(19) United States
(12) Patent Application Publication
(10) Pub. No.: US 2014/0359299 A1
(43) Pub. Date: Dec. 4, 2014

(54) Method for Determination of User's Identity

(71) Applicant: RELATIVE CC, SIA, Riga (LV)

(72) Inventor: Aigars Jaundalders, Riga (LV)

(21) Appl. No.: 14/344,911

(22) PCT Filed: Oct. 2, 2012
(86) PCT No.: PCT/LV2012/000015

§ 371 Date: Mar. 14, 2014

(30) Foreign Application Priority Data
Oct. 4, 2011 (LV) P-11-134

(51) Int. Cl. H04L 9/32; H04W 12/06

(52) U.S. Cl. CPC H04L 9/3247; H04L 9/3263; H04W 12/06
USPC 713/179

(57) ABSTRACT

Method and system for determination of user's identity described herein, ensures a secure user authentication process using mobile device, e.g. a phone. Method can be used with any service provider resource site, not limited to a website on Internet accessed from the personal computer. The only technological pre-requisite for such a resource site, is capability to display a dynamically generated login/enrollment image. Method can be implemented for any operating system, browser or software API.

### CROSS-REFERENCE TO RELATED APPLICATION

This application claims the benefit of the priority filing date of international application No. PCT/LV2012/000015 filed on Oct. 2, 2012 and published as WO/2013/051916. The earliest priority filing date claimed is Oct. 4, 2011.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention refers to the information protection in computer networks and systems. A user authentication method exists, using passwords where password fragments are taken from a predefined color image [1].

There is an existing user identification method, using PIN code, whereby user is assigned a unique personal code for accessing information systems [2]. There is an existing password entry method for accessing computer databases, using dynamic computer generated images [3]. There is an existing method for accessing protected services using one time password [4].

User identification methods exist, using usernames and passwords [5-8].

User identification methods exist, complementing username and password entry by additional authentication factors (multi-factor authentication)—one time password generators, printed code cards, biometric elements and other factors [9].

In order to mitigate security risks, all existing methods and systems require users to use complicated passwords that are hard to remember and inconvenient to use. Intrusions into service provider systems to steal user identity data are on the rise. Each additional authentication factor that gets added on top of usernames and passwords brings significant costs and complicates user experience negating expecting security improvements.

### SUMMARY

This invention aims to devise a user authentication method, ensuring a trustworthy identity check, using a mobile device, e.g. phone, without a username and password. This aim is attained by a user capturing a specifically crafted user enrollment image, e.g. barcode or QR-code, on his mobile device displayed by a service provider. The mobile device serializes data received from a photo-sensor into structured data, extracting a service provider identifier, service provider access point resource identifier and unique access token, and/or other data embedded in this image. The mobile device digitally signs the unique access token and/or other data embedded in this image and submits it to a service provider access point accompanied by the mobile phone's public key/digital certificate used to sign that message. The service provider verifies the digital signature of the received message and, if successful, associates the received public key/digital certificate with a profile that user has created.

On repeated visit, the user captures a specifically crafted login image, e.g. barcode or QR-code, on his mobile device that is displayed by service provider. This image, captured by photo-sensor, gets serialized into a structured data, extracting service provider identifier, service provider access point resource identifier and unique access token and/or other data embedded in this image. User selects the same identity that he used during enrollment at this service provider, mobile device digitally signs unique access token and/or other data embedded into the login image, and submits to service provider access point accompanied by his public key/digital certificate used to sign that message. Service provider verifies digital signature of the received message, matches the user profile via a public key/digital signature that was stored during enrollment and enables a user session for the received unique access token or other data embedded in a login image.

### DESCRIPTION

In order to start using a system from a service provider (e.g. email, forums, e-commerce service, interactive TV service, etc.) that is mostly available in online form, the user opens the service resource page from a computer or any other device. The user creates a profile at this service provider, specifying information the service provider requests specifically to render a particular service. If a user has already created a profile at a particular service provider, the user authenticates into that profile via any authentication means that he may have been using at the time of profile creation. The user captures a specifically crafted enrollment image, e.g. barcode or QR code, with an application on this mobile device, for example, a smartphone. An Application serializes data captured by the photo-sensor, into structured data, extracting a service provider identifier, a service provider access point resource identifier, and a unique access token and/or other data embedded in this image. The mobile device digitally signs a unique access token and/or other data embedded in this image and submits it to the service provider access point accompanied by the mobile phone's public key/digital certificate used to sign that message. The service provider verifies the digital signature of the received message and, if successful, associates the received public key/digital certificate with a profile the user created.

On occasions when additional security checks are required to start using a service, e.g. banking services, users may be required to attend service provider premises in person. Service provider may then present an enrollment image to the user in person, for example, printing it on the service sign-up form, showing on a computer screen, etc. The user then captures this enrollment image with an app on his mobile device and proceeds with next enrollment steps as described above.

On repeated visit, the user captures a specifically crafted login image, e.g. barcode or QR-code, on his mobile device that is displayed by the service provider. This image, captured by photo-sensor, gets serialized into a structured data, extracting a service provider identifier, a service provider access point resource identifier, and a unique access token and/or other data embedded in this image. The user selects the same identity that he used during enrollment at this service provider. The mobile device digitally signs the unique access token and/or other data embedded into the login image, and submits it to the service provider access point accompanied by his public key/digital certificate used to sign that message. The service provider verifies the digital signature of the received message, matches the user profile via the public key/digital signature that was stored during enrollment, and enables a user session for the received unique access token or other data embedded in the login image. This completes the user authentication process.

On occasions, when the service provider needs to implement additional security controls during the login process, the service provider may register an IP address of the originating mobile device used to submit the login request message and deploy geo-location restrictions for a subsequently enabled user session. For example, a service provider may allow accessing a user session only from devices that are in close proximity to the IP address of the originating mobile device, making it more complicated to launch any identity theft attacks.

### REFERENCES

1. Patent RU 2348974, C2, G06K9100, 2008
2. Patent RU 2385233, CI, B42D15110, 2008
3. Patent RU 2263341, CI, G06FIIOO, 2005
4. Patent RU 2308755, C2, G06F17/00, 2005
5. Patent application U.S. 2008/0120717, AI, G06F21/00, 2008
6. Patent application U.S. 2009/0307182, AI, G06N5/02, 2009
7. Patent application U.S. 200910228370, AI, G06Q30100, 2009
8. Patent application WO 20081151209, AI, H04KIIOO, 2006
9. Patent RU 2382408, C2, G06K9100, 2008

1. A method for determination of a user's identity, involving creation of a new user profile or authenticating into an existing user profile via pre-existing authentication means, wherein, after creating a user profile, user captures a specifically crafted enrollment image, e.g. barcode or QR code, with an application on a mobile device, for example, a smartphone;
an application serializes data captured by photo-sensor, into structured data, extracting a service provider identifier, a service provider access point resource identifier and a unique access token and/or other data embedded in this image, digitally signs unique access token and/or other data embedded in said image;
mobile device digitally signs a unique access token and/or other data embedded in said image and submits said image to a service provider access point accompanied by user's public key/digital certificate used to sign a message;
service provider verifies digital signature of received message and, if successful, associates received public key/digital certificate with a profile that user has created;
on repeated visit, user captures a specifically crafted login image, e.g. barcode or QR-code, on user's mobile device that is displayed by service provider; said image, captured by photo-sensor, gets serialized into a structured data, extracting the service provider identifier, the service provider access point resource identifier and the unique access token and/or other data embedded in said image; user selects the same identity that user used during enrollment at service provider, mobile device digitally signs the unique access token and/or other data embedded into the login image, and submits said token, data and/or image to service provider access point accompanied by user's public key/digital certificate used to sign the message; service provider verifies the digital signature of received message, matches the user profile via the public key/digital signature that was stored during enrollment and enables a user session for the received unique access token or other data embedded in login image, thereby completing user authentication process.
